(19) United States
(12) Patent Application Publication
(10) Pub. No.: US 2010/0214592 A1
(43) Pub. Date: Aug. 26, 2010

(54) Image Processor Having Function for Writing Data to and Reading Data From Storage Unit Attached on Sheet

(75) Inventor: Kazushige Muroi, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/691,167

(22) Filed: Jan. 21, 2010

(30) Foreign Application Priority Data
Feb. 25, 2009 (JP) 2009-042632

(51) Int. Cl. G06K 15/02

(52) U.S. Cl. 358/1.14

(57) ABSTRACT

An image processing device includes a supply unit, a sheet tray, a conveying unit, an image processing unit, an access unit, and a control unit. A sheet having a storage unit is set in the supply unit. The image processing unit performs an image processing operation for reading an image from the sheet or for printing an image on the sheet. The access unit performs an access operation including at least one of a process for reading data from the storage unit and a process for writing data to the storage unit. The control unit determines whether the access operation for the sheet is successfully performed. The control unit further controls the access unit, based on the determination, to perform re-access operation to the sheet for which the access operation results in failure upon resetting the sheet discharged to the discharge tray onto the supply unit.

### CROSS REFERENCE TO RELATED APPLICATION

This application claims priority from Japanese Patent Application No. 2009-042632 filed Feb. 25, 2009. The entire content of the priority application is incorporated herein by reference.

### TECHNICAL FIELD

The present invention relates to an image processor, and particularly to an image processor having a function for forming an image on a sheet or for reading an image from a sheet, and a function for writing data to or reading data from an RFID tag or other storage unit attached to the sheet.

### BACKGROUND

Recently, printers (image processors) have been developed with functions for printing an image on a sheet of paper having an IC chip (storage unit) called a radio frequency identification (RFID) tag and for writing data to or reading data from the IC chip.

### SUMMARY

With this conventional printer, attempts to access the IC chip, e.g., to write data to the IC chip, are not always successful, because the printer is able to access the IC chip in the sheet only when the IC chip is passing through an access position. A method has been proposed for handling cases in which the printer fails in an attempt to access the IC chip in a conveyed sheet while the IC chip passes through the access position by reconveying the sheet to the access position along a reconveying path and reattempting to access the IC chip. However, all the sheets for which the IC chip accessing operation was failed are not reconveyed to the access position for re-accessing but only the sheets that are subject to double-side printing. Before performing the reverse-side printing, the re-accessing operation is performed if the initial accessing operation was failed.

The above method is not always effective as a means of recovery when the printer fails to access the IC chip and, therefore, another method is needed.

In view of the foregoing, it is an object of the present invention to provide an image processor capable of smoothly recovering from a failed access to a storage unit provided with a sheet of a recording medium, such as an attempt to write data to the storage unit.

In order to achieve the object, the present invention provides an image processing device. The image processing device includes a supply unit, a sheet tray, a conveying unit, an image processing unit, an access unit, and a control unit. A sheet having a storage unit is set in the supply unit. The conveying unit conveys the sheet from the supply unit and discharges the sheet onto the sheet tray. The image processing unit performs an image processing operation for reading an image from the sheet or for printing an image on the sheet. The access unit performs an access operation including at least one of a process for reading data from the storage unit and a process for writing data to the storage unit. The control unit controls the image processing unit to perform the image processing operation, further controls the access unit to perform the access operation to the sheet conveyed by the conveying unit, and determines whether the access operation for the sheet is successfully performed or failed. The control unit further controls the access unit, based on the determination, to perform re-access operation to the sheet for which the access operation results in failure upon resetting the sheet discharged to the sheet tray onto the supply unit.

According to another aspect, the present invention provides a method for controlling an image processing device. A sheet having a storage unit is processed in the image processing device. The method includes (a) conveying the sheet from a supply unit and discharging the sheet onto a sheet tray, (b) performing an image processing operation for reading an image from the sheet or for printing the image on the sheet, (c) performing an access operation with an access unit, the access operation including at least one of a process for reading data from the storage unit and a process for writing data to the storage unit, (d) determining whether the access operation for the sheet is successfully performed or failed; and (e) upon resetting the sheet discharged to the discharge tray onto the supply unit, performing re-access operation to the sheet based on the (d) determination indicating that the access operation for the sheet is failed.

### BRIEF DESCRIPTION OF THE DRAWINGS

The particular features and advantages of the invention as well as other objects will become apparent from the following description taken in connection with the accompanying drawings, in which:

FIG. 1 is a block diagram showing a simplified electrical structure of a printer according to a first embodiment of the present invention;

FIG. 2 is a cross-sectional view showing a simplified configuration of the printer;

FIG. 3 is a flowchart illustrating steps in a printing/writing process executed by the printer;

FIG. 4 is a flowchart illustrating steps in a recovery process executed by the printer;

FIG. 5 is a flowchart illustrating steps in the printing/writing process according to a second embodiment of the present invention;

FIG. 6 is a flowchart illustrating steps in the recovery process according to the second embodiment;

FIG. 7 is a block diagram showing a simplified electrical structure of a multifunction peripheral according to a third embodiment of the present invention;

FIG. 8 is a cross-sectional view showing a simplified configuration of the multifunction peripheral;

FIG. 9 is a flowchart illustrating steps in a scanning process executed on the multifunction peripheral; and

FIG. 10 is a flowchart illustrating steps in a recovery process executed on the multifunction peripheral.

### DETAILED DESCRIPTION

### First Embodiment

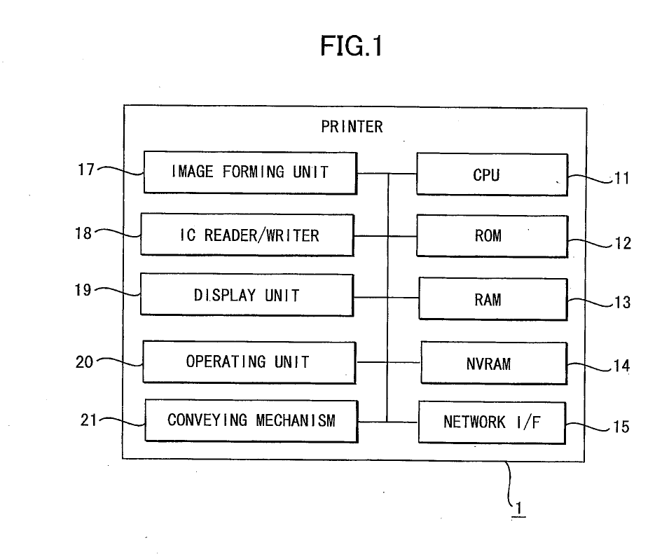

Next, a first embodiment of the present invention will be described with reference to FIGS. 1 through 4.

(Structure of a Printer)

As shown in FIG. 1, the printer 1 includes a CPU 11, a ROM 12, a RAM 13, a NVRAM (nonvolatile memory) 14, and a network interface 15; and, connected to these components via a bus line, an image-forming unit 17, an IC reader/writer 18, a display unit 19, an operating unit 20, and a conveying mechanism 21.

The ROM 12 stores programs for implementing various operations on the printer 1, such as a printing/writing process described later. The CPU 11 controls each component of the printer 1 while storing processing results obtained when executing programs read from the ROM 12 in the RAM 13 or NVRAM 14. The network interface 15 connects the printer 1 to an external computer (not shown) or the like via a network line, enabling bi-directional data communications between the two devices.

The image-forming unit 17 is adapted to forms an image on a sheet 25 of paper using colorant (ink or toner) in one or a plurality of colors. The IC reader/writer 18 is adapted to communicate with an RFID tag 25A attached to the sheet 25 through radio waves, by which the IC reader/writer 18 can implement at least one of a reading operation for reading data recorded in the RFID tag 25A and a writing operation for writing data to the RFID tag 25A. Hereinafter, these reading and writing operations will also be referred to as “accesses.”

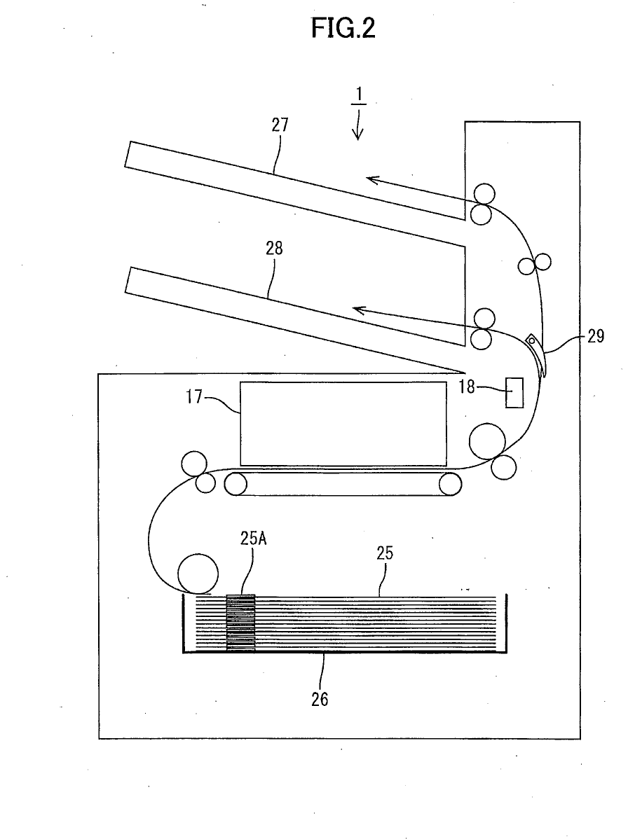

The display unit 19 includes a display for displaying configuration screens, the status of device operations, and the like; and indicator lamps. The operating unit 20 includes a plurality of buttons by which the user can input instructions for initiating operations and the like. The conveying mechanism 21 includes a belt and a plurality of rollers for conveying the sheets 25, and a flapper 29 (see FIG. 2) disposed downstream of the image-forming unit 17 and IC reader/writer 18 for switching the conveying path between to two discharge paths.

As shown in FIG. 2, the printer 1 also includes a paper tray 26 accommodating a plurality of overlaid sheets 25. The conveying mechanism 21 feeds the topmost sheet 25 accommodated in the paper tray 26 and conveys the sheet to an image-forming position at which the image-forming unit 17 can form an image on the sheet 25. Subsequently, the conveying mechanism 21 conveys the sheet 25 to an access position at which the IC reader/writer 18 can access the RFID tag 25A.

The printer 1 also includes a first tray 27 and a second tray 28, each of which is capable of accommodating a plurality of sheets 25. After the sheet 25 has passed through the access position, the conveying mechanism 21 guides and conveys the sheet 25 to one of the trays 27 and 28 as directed by the flapper 29.

(Printing/Writing Process)

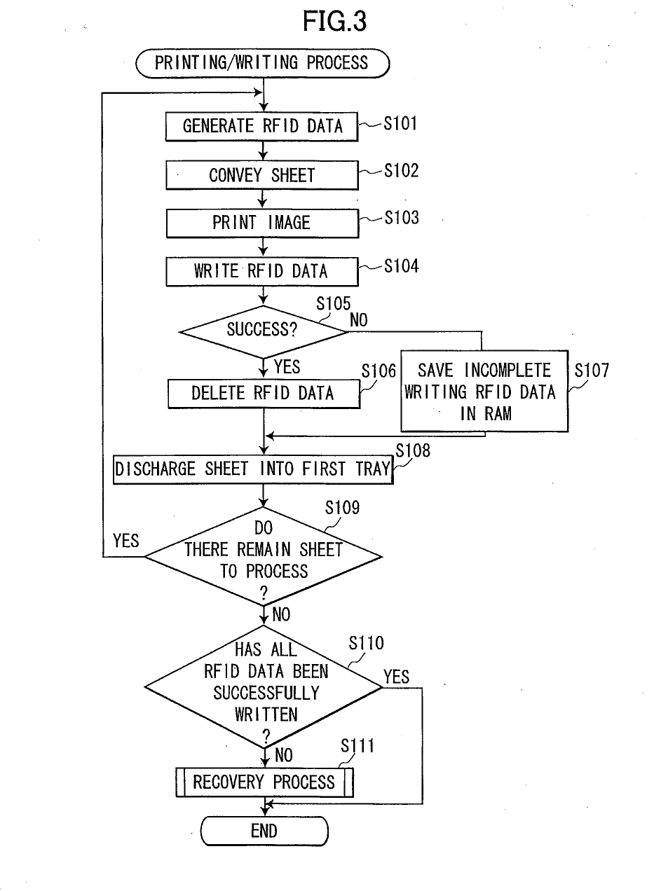

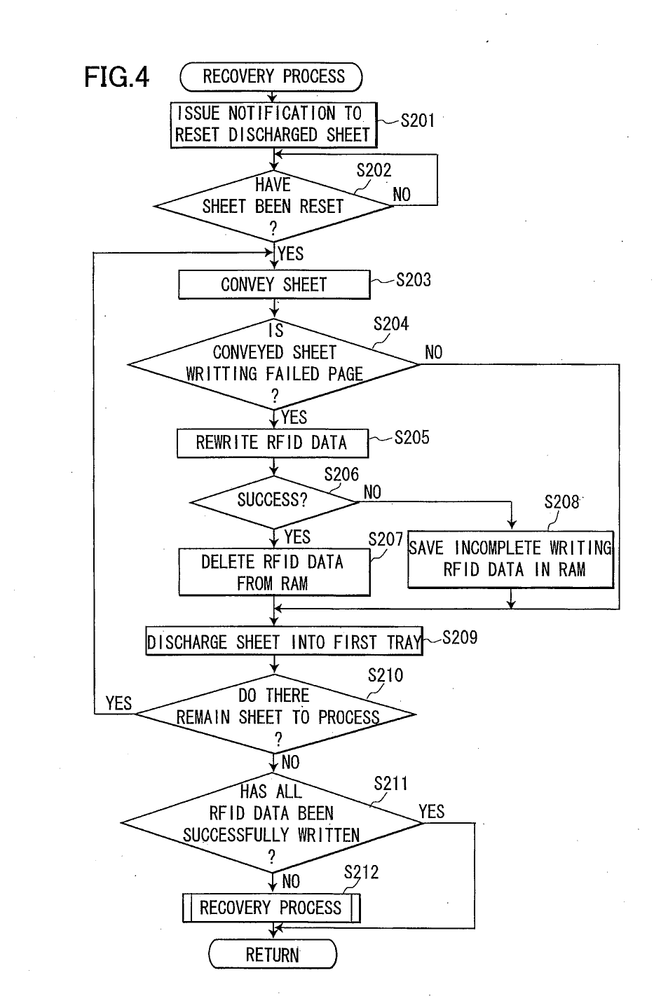

FIGS. 3 and 4 are flowcharts illustrating steps in a printing/writing process and recovery process executed by the CPU 11 of the printer 1. The printing/writing process is performed to print images on sheets 25 having respective RFID tags 25A and to write data to the RFID tag 25A. The CPU 11 executes the printing/writing process upon receiving a print/write command via the network interface 15 from an external computer or the like connected to the printer 1, for example. A print/write command includes image data to be printed; settings for various printing conditions, such as number of pages, number of colors (color or monochrome, for example), and resolution; and instructions on the content to be written to the RFID tags 25A.

In S101 at the beginning of the printing/writing process shown in FIG. 3, the CPU 11 generates RFID data in the RAM 13, which data is to be written to the RFID tag 25A of one sheet 25, based on the instructions included in the print/write command. The RFID data created in S101 may include the username of the user operating the computer or the like from which the print/write command was received, the date and time of execution, and printing conditions, as well as data for an image to be printed.

In S102 the CPU 11 controls the conveying mechanism 21 to convey one sheet 25 having an RFID tag 25A from the paper tray 26. In S103 the CPU 11 controls the image-forming unit 17 to print an image on the sheet 25 based on image data included in the print/write command. In S104 the CPU 11 controls the IC reader/writer 18 to write RFID data to the RFID tag 25A of the sheet 25 when the RFID tag 25A reaches the access position. At this time, the CPU 11 determines whether the writing operation was successful, that is, whether all of the RFID data was written to the RFID tag 25A.

More specifically, the CPU 11 controls the IC reader/writer 18 to read data that has been written to the RFID tag 25A while the RFID tag 25A is still passing through the access position, and determines the consistency between the read data and the written data. When the data do not match or the data cannot be read, this data is set as incomplete writing data and the CPU 11 determines that the writing operation was not completed normally.

Alternatively, the CPU 11 may divide the RFID data to be written to the RFID tag 25A into a plurality of parts and may sequentially write data and read the written data for each part and determine whether the data for each part matches. If there exists any part for which the data does not match or for which data could not be written or read normally, the data for this part is set as incomplete writing data and the CPU 11 determines that the writing operation was not completed normally.

If the CPU 11 determines that data was written normally to the RFID tag 25A (S105: YES), in S106 the CPU 11 deletes the original RFID data from the RAM 13. However, if the CPU 11 determines that the operation for writing data to the RFID tag 25A failed (S105: NO), in S107 the CPU 11 stores at least the portion of the original RFID data that includes the incomplete writing data in the RAM 13.

At the same time, the CPU 11 stores identification data identifying the sheet 25 for which writing failed in the RAM 13 together with the incomplete writing data. The identification data may be a sequence number (page number) of the sheet 25 for which writing failed, for example. Alternatively, if the RFID tag 25A has a pre-stored authentication number the CPU 11 may read the authentication number at the time of writing and may store this authentication number as the identification data. After storing the incomplete writing data, the CPU 11 deletes the original RFID data from the RAM 13.

In S108 the CPU 11 controls the conveying mechanism 21 to discharge the sheet 25 into the first tray 27. In S109 the CPU 11 determines whether the number of pages specified in the print/write command has been printed. If there remain pages to be printed (S109: YES), the CPU 11 returns to S101 and repeats the process described above in S101-S108 for the next page.

If the printing and writing operations have been completed for all pages (S109: NO), in S110 the CPU 11 determines whether writing was successful for all sheets 25 for which a writing operation was performed. If the writing operation was successful for all pages (S110: YES), the CPU 11 ends the printing/writing process. However, if the writing process failed for any of the sheets 25 (S110: NO), in S111 the CPU 11 executes the recovery process described next.

In the recovery process, the CPU 11 attempts to rewrite RFID data to the RFID tags 25A of sheets 25 for which the writing operation failed. In S201 at the beginning of the recovery process shown in FIG. 4, the CPU 11 issues a notification to the user indicating that there exist sheets 25 for which RFID data was not properly written and prompting the user to retrieve the sheets 25 discharged from the first tray 27 and to reset these sheets 25 in the paper tray 26.

The notification may be performed by displaying a message on the display unit 19 or by outputting an audio message through an audio device (not shown) provided in the printer 1. The printer 1 may also transmit a signal for data of the notification via the network interface 15 to the computer that transmitted the print/write command, so that the computer can display a message on a display unit upon receiving the signal. After receiving the notification, the user retrieves the sheets 25 from the first tray 27 and resets the sheets 25 in the paper tray 26. If a plurality of sheets 25 has been discharged in the first tray 27, the user retrieves all sheets 25 at this time and resets all sheets 25 in the paper tray 26 without changing the order of the sheets 25 or extracting the problematic sheets.

In S202 the CPU 11 waits until the user has reset the sheets 25. Specifically, the CPU 11 waits until data indicating that the sheets 25 have been reset in the paper tray 26 is acquired, such as when the user inputs a command on the operating unit 20 (or the external computer or the like) indicating that the sheets 25 have been reset (or a command to re-execute the writing operation). Alternatively, the CPU 11 may wait for a sensor (not shown) provided for detecting opening and closing of the paper tray 26 to detect that the paper tray 26 was opened and subsequently closed.

When the sheets 25 have been reset (S202: YES), in S203 the CPU 11 controls the conveying mechanism 21 to begin conveying one sheet 25 from the paper tray 26. In the recovery process, the CPU 11 does not direct the image-forming unit 17 to print an image but conveys the sheet 25 through the image-forming position to the access position.

In S204 the CPU 11 determines whether the conveyed sheet 25 is a page for which writing of RFID data failed, based on the existing identification data. For example, the CPU 11 determines whether the currently conveyed sheet 25 corresponds to a sequence number (page number) when sequence numbers of sheets 25 for which writing failed are stored as the identification data. If authentication numbers of RFID tags 25A for which writing failed are stored as the identification data, the CPU 11 controls the IC reader/writer 18 to read the authentication number from the RFID tag 25A of the currently conveyed sheet 25 and compares this authentication number with the stored identification data.

If the currently conveyed sheet 25 is not a page for which writing failed (S204: NO), the CPU 11 does not execute a rewriting operation but jumps to S209 to discharge the sheet 25 into the first tray 27.

However, if the conveyed sheet 25 is a page for which writing failed (S204: YES), in S205 the CPU 11 reads from the RAM 13 or the like the RFID data corresponding to this page that was not written and executes a rewriting operation to write this data to the RFID tag 25A. The data written to the RFID tag 25A at this time is added to data that was successfully written in the previous writing operation. In S206 the CPU 11 determines whether the rewriting operation was successful. If successful (S206: YES), in S207 the CPU 11 deletes the original RFID data from the RAM 13. If not successful (S206: NO), in S208 the CPU 11 saves the incomplete writing data to the RAM 13 together with the identification data and deletes the original RFID data from the RAM 13.

In the rewriting operation described above, the printer 1 can omit at least part of the writing operation for the portion of data that was successfully written in the previous writing operation. Hence, the printer 1 can rewrite a smaller amount of data in the writing operation when there already exists some data that was successfully written in the previous operation than when rewriting all of the data. Accordingly, there is a greater likelihood that the printer 1 can complete the rewriting operation normally.

In S209 the CPU 11 discharges the sheet 25 into the first tray 27 and in S210 determines whether there remain sheets 25 to process. The CPU 11 returns to S203 and repeats the same process described above if there remain unprocessed sheets 25 (S210: YES). When the process has been completed for all sheets 25 (S210: NO), in S211 the CPU 11 determines whether all RFID data has been successfully written. If all RFID data has been successfully written (S211: YES), the CPU 11 exits the recovery process and returns to the printing/writing process of FIG. 3. However, if there still exist any sheets 25 for which writing failed (S211: NO), in S212 the CPU 11 re-executes the recovery process.

According to the method described above, the printer 1 repeats the recovery process until writing is successfully completed for all pages specified in the print/write command. However, it is possible to restrict the number of times that the recovery process is executed. For example, if there still remains an RFID tag 25A for which writing could not be executed after performing the recovery process twice, the CPU 11 may display a message on the display unit 19 indicating that a writing error has occurred and subsequently end the recovery process.

### Effects of the First Embodiment

In the first embodiment described above, the printer 1 executes a printing operation and a writing operation on sheets 25 with RFID tags 25A. If any of the writing operations has failed, the printer 1 directs the user to reset the discharged sheets 25 in the paper tray 26. The printer 1 determines which of the sheets 25 set in the paper tray 26 are sheets 25 for which writing failed and executes a rewriting operation on these sheets 25 to compensate for the failed portions of the previous writing operation, thereby achieving a smooth recovery when the initial writing operation failed.

In order to perform the rewriting operation in the preferred embodiment, the printer 1 does not require a special configuration, such as a reconveying path, or a special function for reconveying the sheets 25 for which a writing operation failed back to the access position via the reconveying path. Accordingly, recovery can be achieved through a simple configuration and without providing a reconveying path.

When performing the rewriting operation, the printer 1 identifies sheets 25 for which a writing operation failed based on identification data or the like stored in the RFID tag 25A. Thus, sheets 25 for which the writing operation failed can easily be identified.

When a sheet 25 set in the paper tray 26 for the rewriting operation is not one of the sheets 25 for which the writing operation failed, the printer 1 simply discharges the sheet without rewriting data to the RFID tag 25A attached thereto, thereby eliminating unnecessary rewriting operations on sheets 25 for which the writing operation was completed.

The printer 1 also does not perform image formation on the sheets 25 in the rewriting operation, thereby eliminating an unnecessary process of reforming an image on a sheet 25 after the image was already formed thereon.

During the rewriting operation, the printer 1 rewrites only the portion of data including data that was not properly written in the initial writing operation. Accordingly, the amount of data that the printer 1 has to write is less than if the printer 1 were to repeat the writing operation for all data, thereby increasing the chance that the rewriting operation will succeed. Further, this method can reduce the amount of memory usage in the RAM 13 or the like.

When a writing operation has failed, the printer 1 prompts the user to reset the discharged sheets 25 in the paper tray 26, enabling the user to take the proper action.

When a writing operation has failed, the printer 1 begins the rewriting operation after acquiring data indicating that the sheets 25 have been reset in the paper tray 26 (for example, data inputted by the user on the operating unit 20 indicating that the sheets 25 are set, or data indicating that a sensor has detected the sheets 25 being set in the paper tray 26). Accordingly, the printer 1 can achieve smooth recovery by executing the rewriting operation at a suitable timing.

### Second Embodiment

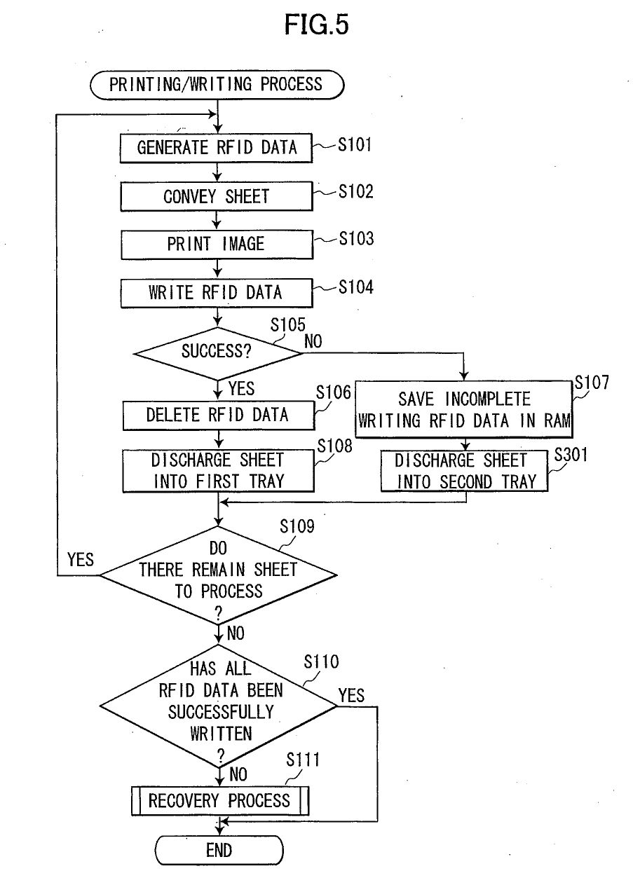

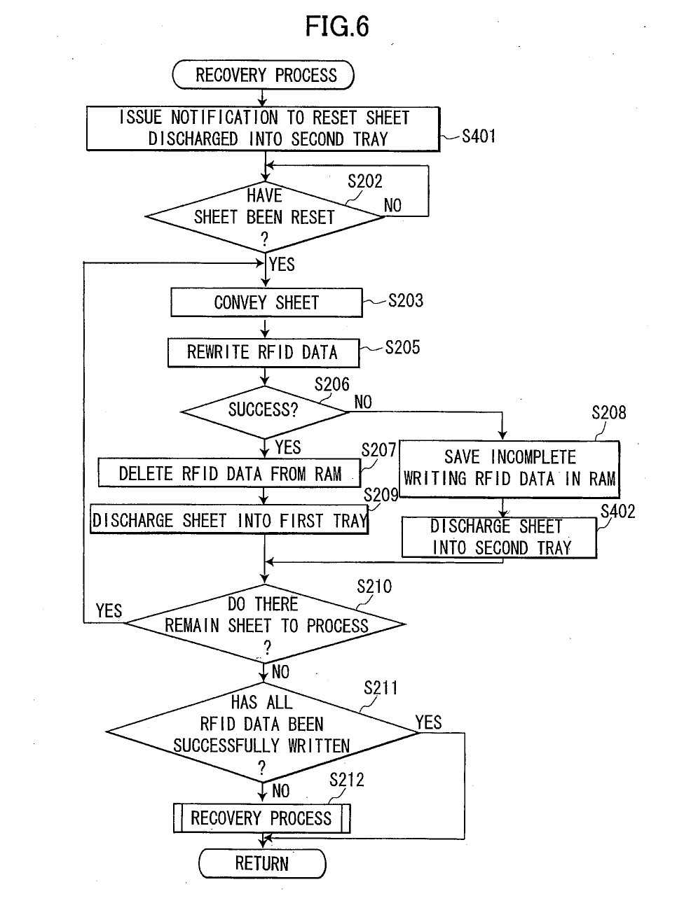

Next, a second embodiment of the present invention will be described with reference to FIGS. 5 and 6.

(Printing/Writing Process)

FIGS. 5 and 6 are flowcharts illustrating steps in a printing/writing process and a recovery process according to the second embodiment of the present invention. In the second embodiment, the printer 1 sorts the sheets 25 into those for which the writing operation succeeded and those for which the writing operation failed when discharging the sheets 25. Since most of the steps in the printing/writing process according to the second embodiment are identical to those in the first embodiment, like steps have been designated with the same step numbers to avoid duplicating description.

When the CPU 11 determines that a writing operation was successful after writing RFID data in S104 of the printing/writing process shown in FIG. 5 (S105: YES), in S106 the CPU 11 deletes the RFID data from the RAM 13 and in S108 discharges the sheet 25 into the first tray 27. However, when the CPU 11 determines that the operation to write RFID data failed (S105: NO), in S107 the CPU 11 stores at least the portion of original RFID data including the incomplete writing data into the RAM 13 or the like together with identification data identifying the sheet 25 for which the writing operation failed. In S301 the CPU 11 controls the conveying mechanism 21 to discharge the sheet 25 for which the writing operation failed into the second tray 28.

After completing the above process for all pages specified in the print/write command, all sheets 25 to which RFID data was successfully written are sorted into the first tray 27 while all sheets 25 for which data was unsuccessfully written are sorted into the second tray 28. If the CPU 11 subsequently determines in S110 that there exist sheets 25 for which the writing operation failed (S110: NO), in S111 the CPU 11 executes the recovery process shown in FIG. 6.

In S401 of the recovery process shown in FIG. 6, the CPU 11 issues a notification to the user indicating that there exist sheets 25 for which RFID data could not be written successfully and prompting the user to reset the sheets 25 discharged into the second tray 28 in the paper tray 26. Upon receiving this notification, the user retrieves the sheets 25 from the second tray 28 and resets these sheets 25 (i.e., all sheets 25 for which writing was unsuccessful) in the paper tray 26.

After the sheets 25 have been reset (S202: YES), in S203 the CPU 11 conveys one sheet 25 from the paper tray 26 and in S205 rewrites the incomplete writing data to the RFID tag 25A. If the RFID data was successfully written at this time (S206: YES), in S207 the CPU 11 deletes the original RFID data from the RAM 13 and in S209 discharges the sheet 25 into the first tray 27. However, if the rewriting operation failed (S206: NO), in S208 the CPU 11 saves the incomplete writing data to the RAM 13 and in S402 discharges the sheet 25 into the second tray 28.

After performing the above operation on all sheets 25 that were reset in the paper tray 26, sheets 25 for which the rewriting operation succeeded have been sorted into the first tray 27 while sheets 25 for which the rewriting operation failed have been sorted into the second tray 28. If the CPU 11 subsequently determines in S211 that there exist sheets 25 for which the rewriting operation failed (S211: NO), in S212 the CPU 11 re-executes this recovery process.

### Effects of the Second Embodiment

In the second embodiment described above, the printer 1 executes a printing operation and a writing operation on each sheet 25. When the writing operation fails for any of the sheets 25, the printer 1 can identify the sheets 25 for which the writing operation failed. After prompting the user to reset only the sheets 25 for which the writing operation failed in the paper tray 26, the printer 1 executes a rewriting operation to compensate for data that could not be successfully written to the sheet 25 in the initial writing operation, thereby achieving a smooth recovery when a writing operation has failed.

Further, the printer 1 sorts the successfully written sheets 25 from the unsuccessfully written sheets 25 when discharging the sheets 25. Accordingly, the user can easily extract only those sheets 25 for which the writing operation failed and reset these sheets 25 in the paper tray 26.

### Third Embodiment

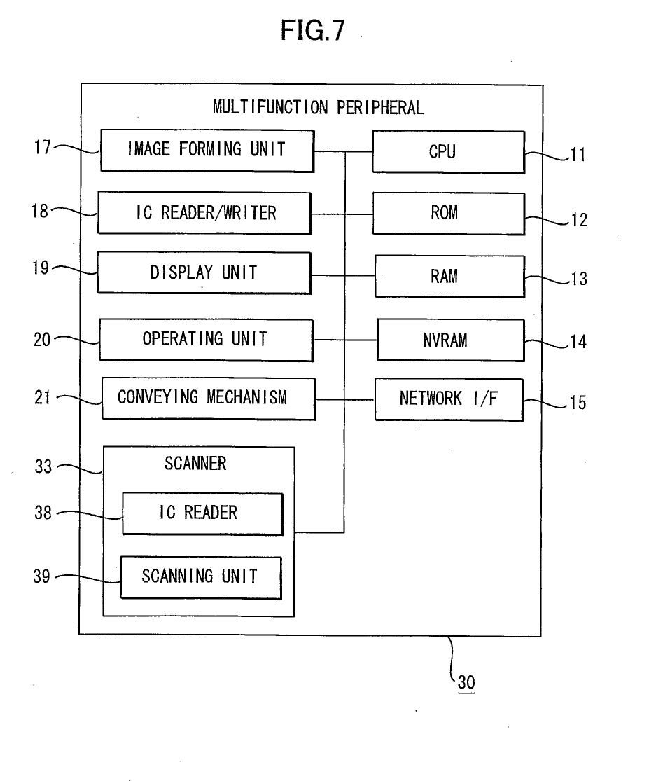

Next, a third embodiment of the present invention will be described with reference to FIGS. 7 through 10.

(General Structure of a Multifunction Peripheral)

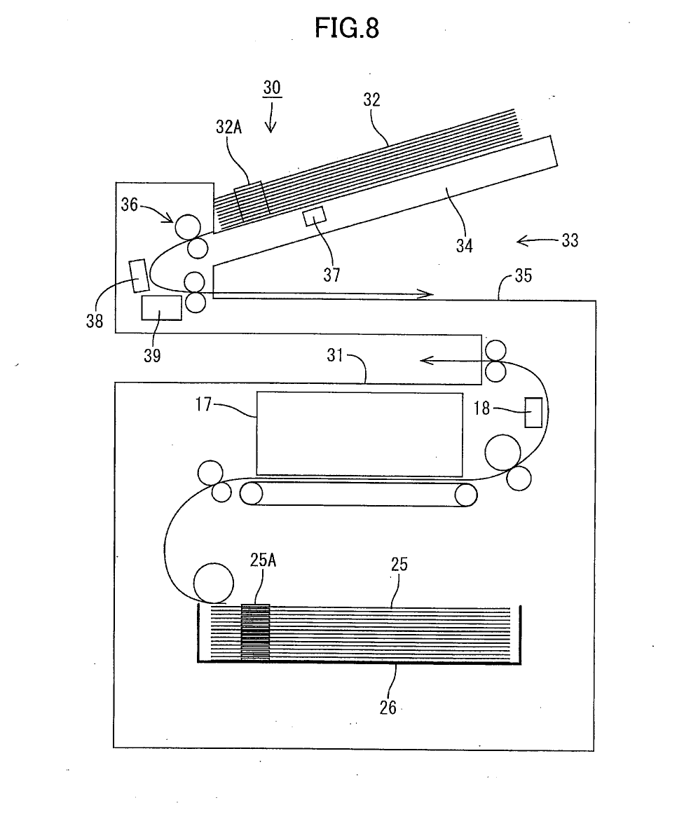

FIG. 7 is a block diagram showing a simplified electrical structure of a multifunction peripheral (MFP) 30. FIG. 8 is a cross-sectional view showing a simplified configuration of the MFP 30. In the third embodiment, like parts and components to those in the first and second embodiments described above have been designated with the same reference numerals to avoid duplicating description.

As shown in FIGS. 7 and 8, the MFP 30 includes the image-forming unit 17 for printing images on sheets 25 set in the paper tray 26, the IC reader/writer 18 for writing data to RFID tags 25A attached to the sheets 25, and a discharge tray 31 into which the sheets 25 are discharged. The MFP 30 also includes a scanner 33 for scanning sheets of an original document (hereinafter referred to as “original sheets 32”).

The scanner 33 is provided with a supply tray 34 and a discharge tray 35, each of which is capable of accommodating a plurality of original sheets 32, and a conveying mechanism 36 for conveying original sheets 32 one sheet at a time from the supply tray 34 to the discharge tray 35. A document sensor 37 is also provided on the supply tray 34 for optically detecting the presence of original sheets 32. The scanner 33 also includes an IC reader 38 disposed along the conveying path of the original sheets 32 for communicating through radio waves with an RFID tag 32A attached to the original sheet 32 in order to read data recorded in the RFID tag 32A, and a scanning unit 39 for scanning the original sheet 32 and outputting image data corresponding to the original image formed on the original sheet 32.

(Scanning Process)

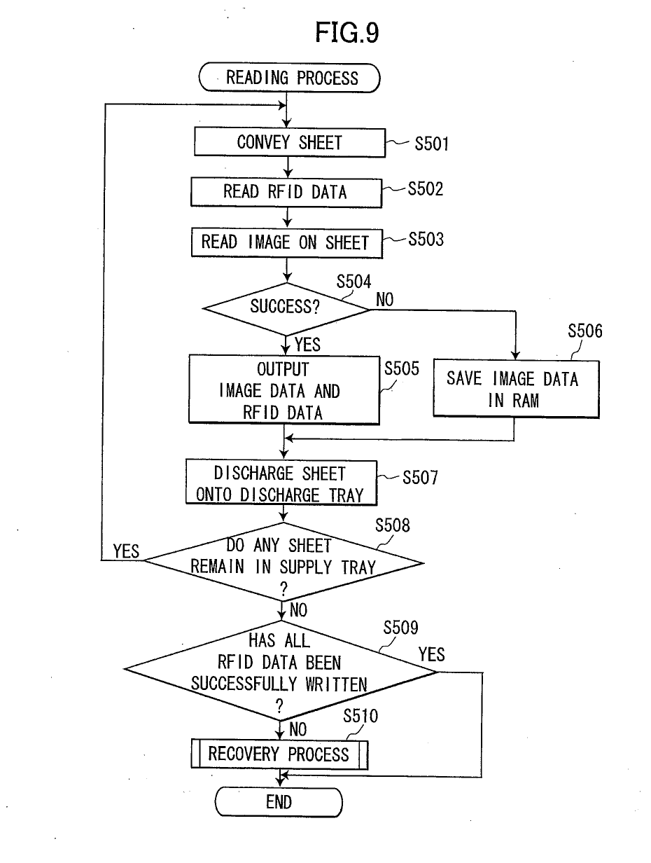

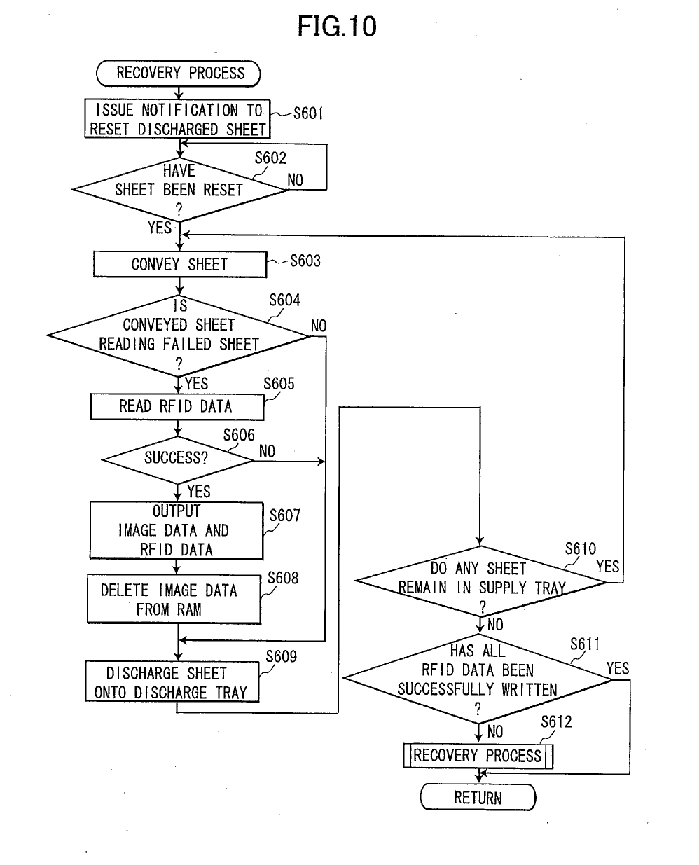

FIGS. 9 and 10 are flowcharts illustrating steps in a scanning process executed by the CPU 11 of the MFP 30. The scanning process is performed to scan an original image from an original sheet 32 having an RFID tag 32A and for reading RFID data stored in the RFID tag 32A. In the third embodiment, the MFP 30 transmits the image data and RFID data acquired in the scanning process to an external computer or the like via the network interface 15.

In S501 at the beginning of the scanning process shown in FIG. 9, the CPU 11 controls the conveying mechanism 36 to feed one original sheet 32 from the supply tray 34. In S502 the CPU 11 controls the IC reader 38 to read RFID data stored in the RFID tag 32A of the original sheet 32. In S503 the CPU 11 controls the scanning unit 39 to scan an original image on the original sheet 32.

In S504 the CPU 11 determines whether the RFID data was read successfully. If so (S504: YES), in S505 the CPU 11 outputs the image data and RFID data via the network interface 15. However, if the RFID data was not read successfully (S504: NO), in S506 the CPU 11 saves the image data in the RAM 13 together with identification data identifying the original sheet 32 as a sheet for which reading failed. The identification data may be a sequence number (page number) of the original sheet 32 for which reading failed, for example. If the CPU 11 can read an authentication number stored in the RFID tag 32A, this authentication number may be saved as the identification data.

In S507 the CPU 11 controls the conveying mechanism 36 to discharge the original sheet 32 onto the discharge tray 35. In S508 the CPU 11 determines whether any original sheets 32 remain in the supply tray 34 based on output from the document sensor 37. If original sheets 32 remain in the supply tray 34 (S508: YES), the CPU 11 returns to S501 and repeats the above process in S501-S507 for the next original sheet 32.

After the scanning operation has been performed on all original sheets 32 (S508: NO), in S509 the CPU 11 determines whether RFID data could be successfully read from all original sheets 32. If RFID data was successfully read from all original sheets 32 (S509: YES), the CPU 11 ends the scanning process. However, if RFID data could not be successfully read from any of the original sheets 32 (S509: NO), in S510 the CPU 11 executes a recovery process described next.

In the recovery process shown in FIG. 10, the MFP 30 attempts to reread data from the RFID tags 32A of original sheets 32 for which reading failed initially. In S601 at the beginning of the recovery process shown in FIG. 10, the CPU 11 issues a notification to the user indicating that data could not be successfully read from some original sheets 32 and prompting the user to reset the discharged original sheets 32 in the supply tray 34. Upon receiving this notification, the user retrieves all original sheets 32 from the discharge tray 35 and resets these original sheets 32 in the supply tray 34.

In S602 the CPU 11 waits until the user has finished resetting the original sheets 32. The CPU 11 determines whether the original sheets 32 have been reset when the document sensor 37 detects the original sheets 32. When the original sheets 32 have been reset (S602: YES), in S603 the CPU 11 conveys one original sheet 32 from the supply tray 34.

In S604 the CPU 11 determines whether the currently conveyed original sheet 32 was an original sheet 32 from which RFID data could not be read based on the identification data. For example, if a sequence number (page number) of an original sheet 32 for which reading failed has been stored as identification data, the CPU 11 determines whether the conveyed original sheet 32 corresponds to this sequence number. Alternatively, if an authentication number in the RFID tag 32A for which reading failed is stored as the identification data, the CPU 11 controls the IC reader 38 to read the authentication number from the RFID tag 32A of the currently conveyed original sheet 32 and compares this authentication number to the identification data.

If the currently conveyed original sheet 32 is not a page for which reading failed (S604: NO), in S609 the CPU 11 simply discharges the original sheet 32 onto the discharge tray 35 without executing a rereading operation. In this recovery process, the scanning unit 39 does not rescan the original image.

However, if the currently conveyed original sheet 32 is a page for which reading failed (S604: YES), in S605 the CPU 11 controls the IC reader 38 to read RFID data from the RFID tag 32A. In S606 the CPU 11 determines whether the RFID data was read successfully in S605. If so (S606: YES), in S607 the CPU 11 reads the image data acquired from the original sheet 32 in the earlier scanning operation from the RAM 13 and outputs this image data together with the RFID data. In S608 the CPU 11 deletes the image data from the RAM 13 and in S609 discharges the original sheet 32 onto the discharge tray 35. However, if the RFID data could not be successfully read in S605 (S606: NO), in S609 the CPU 11 discharges the original sheet 32 onto the discharge tray 35 without outputting image data or the like.

Subsequently, if the CPU 11 determines that there remain original sheets 32 in the supply tray 34 (S610: YES), the CPU 11 returns to S603 and repeats the above process. When this process has been completed for all original sheets 32 (S610: NO), in S611 the CPU 11 determines whether RFID data was successfully read from all original sheets 32. If so (S611: YES), the CPU 11 exits the recovery process and returns to the scanning process of FIG. 9. However, if there remain original sheets 32 for which reading was unsuccessful (S611: NO), in S612 the CPU 11 re-executes the recovery process.

In the process described above, when RFID data could not be successfully read from any original sheet 32 in the initial reading attempt, the MFP 30 continually repeats the recovery process until RFID data is successfully read from all original sheets 32. However, the MFP 30 may be configured to issue a notification to the user indicating that an error occurred when reading RFID data and to cancel the recovery process after the process has been repeated a prescribed number of times.

### Effects of the Third Embodiment

In the third embodiment described above, the MFP 30 executes a scanning operation to scan original images from original sheets 32 having RFID tags 32A and a reading operation to read RFID data from the RFID tags 32A. If any of the reading operations has failed, the MFP 30 directs the user to reset the discharged original sheets 32 in the supply tray 34. The MFP 30 determines which of the original sheets 32 set in the supply tray 34 are original sheets 32 for which reading failed and executes a rereading operation on these original sheets 32 to compensate for the failed portions of the previous reading operation, thereby achieving a smooth recovery when the initial reading operation failed.

When performing the rereading operation, the MFP 30 identifies original sheets 32 for which a reading operation failed based on identification data or the like stored in the RFID tag 32A. Thus, original sheets 32 for which the reading operation failed can easily be identified.

When an original sheet 32 set in the supply tray 34 is not one of the original sheets 32 for which the reading operation failed, the MFP 30 simply discharges the sheet without rereading data from the RFID tag 32A attached thereto. Accordingly, the preferred embodiment can eliminate unnecessary rereading operations on original sheets 32 for which the reading operation was successful.

The MFP 30 also does not execute a scanning operation on the original sheets 32 when performing a rereading operation, thereby eliminating an unnecessary process of rescanning an image from the original sheet 32 after the image was already scanned.

When a reading operation has failed, the MFP 30 prompts the user to reset the discharged original sheets 32 in the supply tray 34, enabling the user to take the proper action.

When a reading operation has failed, the MFP 30 begins the rereading operation after acquiring data indicating that the original sheets 32 have been reset in the supply tray 34 (for example, data inputted by the user on the operating unit 20 indicating that the original sheets 32 are set, or data indicating that a sensor has detected original sheets 32 in the supply tray 34). Accordingly, the MFP 30 can achieve a smooth recovery by executing the rereading operation at a suitable timing.

### Variations of the Embodiments

While the invention has been described in detail with reference to specific embodiments thereof, it would be apparent to those skilled in the art that many modifications and variations may be made therein without departing from the spirit of the invention, the scope of which is defined by the attached claims.

In the second embodiment described above, the printer 1 sorts sheets 25 that were successfully accessed (for which data was written normally) from sheets 25 that were unsuccessfully accessed when discharging the sheets 25, enabling the user to identify both types of sheets. However, the printer 1 may display data on the display unit 19 identifying which sheets among the discharged sheets could not be accessed (the sequence numbers of the sheets, images formed on the sheets, or data related to images read from the sheets, for example). The display unit 19 serves as an indication unit for indication the sheets for which the initial access operation is failed. The printer 1 may also vary the discharge position in the tray between sheets successfully accessed and sheets unsuccessfully accessed so that the user can differentiate between the two types of sheets, even when the two types are discharged into the same tray. Accordingly, the user can easily extract and reset only those sheets for which access failed. In addition, the printer 1 may also sort sheets for which a reading operation was successful from sheets for which a reading operation was unsuccessful when discharging these sheets.

In the third embodiment described above, the MFP 30 outputs image data and RFID data acquired in the scanning process externally via a network. However, the MFP 30 may be configured to save this image data and RFID data in storage media connected to the MFP 30, for example. Alternatively, when creating a duplicate of an original sheet 32 with an attached RFID tag 32A, the MFP 30 may execute the scanning process and subsequently print an image on a sheet 25 with an attached RFID tag 25A based on the acquired image data and write the acquired RFID data to the RFID tag 25A of the same sheet 25.

If an access is unsuccessful in the printer 1 or MFP 30 of the present invention, the user may be allowed to select whether to execute the recovery process by inputting an instruction on the operating unit 20, for example.

In the first and second embodiments described above, if the IC reader/writer 18 cannot communicate with the RFID tag 25A attached to the sheet 25 in the printing/writing process or if the IC reader/writer 18 cannot successfully write data in the recovery process, the printer 1 may be configured to print the same image formed on the sheet 25 for which writing failed to another sheet 25 fed from the paper tray 26 and to write the RFID data to the RFID tag attached to this sheet 25.

The present invention may be applied to an image-forming device that employs an electrophotographic system, an inkjet system, or another system. Further, the present invention may be applied to a scanner or other device not provided with an image-forming function.

What is claimed is:

1. An image processing device comprising:
a supply unit in which a sheet having a storage unit is set;
a sheet tray;
a conveying unit that conveys the sheet from the supply unit and discharges the sheet onto the sheet tray;
an image processing unit that performs an image processing operation for reading an image from the sheet or for printing an image on the sheet;
an access unit that performs an access operation including at least one of a process for reading data from the storage unit and a process for writing data to the storage unit; and
a control unit that controls the image processing unit to perform the image processing operation, further controls the access unit to perform the access operation to the sheet conveyed by the conveying unit, and determines whether the access operation for the sheet is successfully performed or failed, wherein the control unit further controls the access unit, based on the determination, to perform re-access operation to the sheet for which the access operation results in failure upon resetting the sheet discharged to the discharge tray onto the supply unit.

2. The image processing device according to claim 1, wherein if the control unit determines that the access operation is unsuccessfully performed, the control unit controls the access unit to execute the re-access operation.

3. The image processing device according to claim 1, wherein if the control unit determines that the initial access operation is successfully performed, the control unit controls the access unit not to execute the re-access operation.

4. The image processing device according to claim 1, wherein when the access unit executes re-access operation, the control unit controls the access unit to read data from the storage unit and determines whether the access operation is successfully performed or failed based on the read data.

5. The image processing device according to claim 1, wherein the control unit does not execute the image processing operation when the access unit executes re-access operation.

6. The image processing device according to claim 1, wherein the access unit performs the re-access operation with regard only to a portion of the data that is unsuccessful in the initial access operation.

7. The image processing device according to claim 1, further comprising a notification unit that notifies a user to reset the discharged sheet on the supply unit.

8. The image processing device according to claim 1, further comprising an acquiring unit that acquires information indicating that the sheet has been reset in the supply unit, wherein the control unit controls the access unit to perform the re-access operation based on the information acquired by the acquiring unit when the initial access operation is failed.

9. The image processing device according to claim 1, further comprising an indication unit that indicates the sheet for which the initial access operation is failed.

10. The image processing device according to claim 9, wherein the indication unit comprises a display unit that displays the sheet for which the initial access operation is failed among the discharged sheets.

11. The image processing device according to claim 9, wherein the indication unit sorts the sheet for which the initial access operation is successfully performed from the sheet for which the initial access operation is failed.

12. A method for controlling an image processing device in which a sheet having a storage unit is processed, the method comprising:
(a) conveying the sheet from a supply unit and discharging the sheet onto a sheet tray;
(b) performing an image processing operation for reading an image from the sheet or for printing the image on the sheet;
(c) performing an access operation with an access unit, the access operation including at least one of a process for reading data from the storage unit and a process for writing data to the storage unit;
(d) determining whether the access operation for the sheet is successfully performed or failed; and
(e) upon resetting the sheet discharged to the discharge tray onto the supply unit, performing re-access operation to the sheet based on the (d) determination indicating that the access operation for the sheet is failed.
